(19) United States
(12) Patent Application Publication
(10) Pub. No.: US 2022/0138601 A1
(43) Pub. Date: May 5, 2022

(54) QUESTION RESPONDING APPARATUS, LEARNING APPARATUS, QUESTION RESPONDING METHOD AND PROGRAM

(71) Applicant: NIPPON TELEGRAPH AND TELEPHONE CORPORATION, Tokyo (JP)

(72) Inventors: Kyosuke NISHIDA, Tokyo (JP); Itsumi SAITO, Tokyo (JP); Atsushi OTSUKA, Tokyo (JP); Kosuke NISHIDA, Tokyo (JP); Hisako ASANO, Tokyo (JP); Junji TOMITA, Tokyo (JP)

(73) Assignee: NIPPON TELEGRAPH AND TELEPHONE CORPORATION, Tokyo (JP)

(21) Appl. No.: 17/431,383

(22) PCT Filed: Feb. 10, 2020
(86) PCT No.: PCT/JP2020/005086

§ 371 Date: Aug. 16, 2021

(30) Foreign Application Priority Data
Feb. 18, 2019 (JP) 2019-026546

(51) Int. Cl. G06N 5/04

(52) U.S. Cl. CPC G06N 5/04

(57) ABSTRACT

A question-answering apparatus includes answer generating means of accepting as input a document set made up of one or more documents, a question sentence, and a style of an answer sentence for the question sentence and running a process of generating an answer sentence for the question sentence using a learned model based on the document set, wherein the learned model determines probability of generation of words contained in the answer sentence, according to the style, when generating the answer sentence.

### TECHNICAL FIELD

The present invention relates to a question-answering apparatus, learning apparatus, question-answering method, and program.

### BACKGROUND ART

If “reading comprehension” can be achieved accurately by an artificial intelligence to generate an answer sentence for a question based on a set of given documents, this can be applied to a wide range of services including question-answering and intellectual agent interactions. Such a set of documents is obtained from a result or the like produced by a search engine using a question for a query.

Here, it can be said that generation of an answer sentence by reading comprehension is a summary of a question and document set. Conventional techniques for summarizing a document include, for example, a technique disclosed in Non-Patent Literature 1.

### CITATION LIST

### Non-Patent Literature

Non-Patent Literature 1: Abigail See, Peter J. Liu, Christopher D. Manning, “Get To The Point: Summarization with Pointer-Generator Networks,” ACL (1) 2017: 1073-1083

### SUMMARY OF THE INVENTION

### Technical Problem

Now, as a request from a user, the user may want to specify a style of an answer. For example, as an answer sentence for a question “In what city the 2020 Olympics will be held?,” a style of answering in a word such as “Tokyo” may be required or a style of answering in a natural sentence such as “the 2020 Olympics will be held in Tokyo” may be required.

However, the conventional technique cannot generate answer sentences according to answer styles.

The present invention has been made in view of the above point and has an object to generate answer sentences according to answer styles.

### Means for Solving the Problem

To achieve the above object, an embodiment of the present invention includes answer generating means of accepting as input a document set made up of one or more documents, a question sentence, and a style of an answer sentence for the question sentence and running a process of generating an answer sentence for the question sentence using a learned model based on the document set, wherein the learned model determines probability of generation of words contained in the answer sentence, according to the style, when generating the answer sentence.

### Effects of the Invention

Answer sentences can be generated according to answer styles.

### BRIEF DESCRIPTION OF DRAWINGS

FIG. 1 is a diagram showing an example of a functional configuration (during learning) of a question-answering apparatus according to a first embodiment of the present invention.

FIG. 2 is a diagram showing an example of a functional configuration (during question-answering) of the question-answering apparatus according to the first embodiment of the present invention.

FIG. 3 is a diagram showing an example of data stored in a word vector storage unit.

FIG. 4 is a diagram showing an example of a hardware configuration of the question-answering apparatus according to the first embodiment of the present invention.

FIG. 5 is a flowchart showing an example of a learning process according to the first embodiment of the present invention.

FIG. 6A is a flowchart (1/2) showing an example of a parameter update process according to the first embodiment of the present invention.

FIG. 6B is a flowchart (2/2) showing the example of the parameter update process according to the first embodiment of the present invention.

FIG. 7A is a flowchart (1/2) showing an example of a question-answering process according to the first embodiment of the present invention.

FIG. 7B is a flowchart (2/2) showing the example of the question-answering process according to the first embodiment of the present invention.

FIG. 8 is a diagram showing an example of a functional configuration (during learning) of a question-answering apparatus according to a second embodiment of the present invention.

FIG. 9 is a diagram showing an example of a functional configuration (during question-answering) of the question-answering apparatus according to the second embodiment of the present invention.

FIG. 10 is a flowchart showing an example of a learning process according to the second embodiment of the present invention.

FIG. 11A is a flowchart (1/2) showing an example of a parameter update process according to the second embodiment of the present invention.

FIG. 11B is a flowchart (2/2) showing the example of the parameter update process according to the second embodiment of the present invention.

FIG. 12A is a flowchart (1/2) showing an example of a question-answering process according to the second embodiment of the present invention.

FIG. 12B is a flowchart (2/2) showing the example of the question-answering process according to the second embodiment of the present invention.

### DESCRIPTION OF EMBODIMENTS

Embodiments of the present invention will be described below in detail with reference to the accompanying drawings. Note that the embodiments described below are only exemplary, and the forms to which the present invention is applicable are not limited to the following embodiments. For example, while the technique according to each embodiment of the present invention can be used for question-answering or the like regarding specialized document sets, the technique is not limited to this and can be used for various objects/subjects.

### First Embodiment

First, in the first embodiment, description will be given of a question-answering apparatus 10 that generates an answer sentence according to the answer style using a sentence generation technique based on a neural network when provided with any document set, any question sentence (hereinafter also referred to simply as a “question”) addressed to the document set and an answer style specified, for example, by a user. Here, the answer style is an expression form of the answer sentence, and examples include “word” whereby the answer sentence is expressed only by word, “phrase” whereby the answer sentence is expressed by phrase, and “natural sentence” whereby the answer sentence is expressed by natural sentence. Besides, examples of answer styles include the type (Japanese, English, etc.) of language used for the answer sentence, the feeling (positive, negative) and tense used to express the answer sentence, the tone of voice, and the length (text length) of the answer sentence.

The sentence generation technique based on a neural network includes a stage of learning a neural network (learning stage) and a stage of generating an answer sentence for a question using the learned neural network (question-answering stage). Hereinafter, such a neural network is also referred to as an “answer sentence generating model.” Note that the answer sentence generating model is implemented using one or more neural networks. However, the answer sentence generating model may use any machine learning model in addition to or instead of the neural network (s).

<Functional Configuration of Question-Answering Apparatus 10>

<<During Learning>>

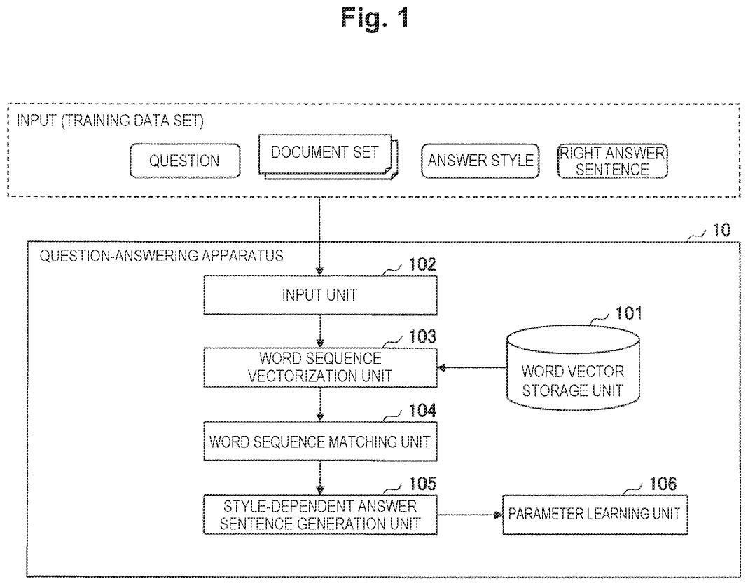

A functional configuration of a question-answering apparatus 10 according to a first embodiment of the present invention during learning will be described with reference to FIG. 1. FIG. 1 is a diagram showing an example of a functional configuration (during learning) of the question-answering apparatus 10 according to the first embodiment of the present invention.

As shown in FIG. 1, during learning, the question-answering apparatus 10 includes a word vector storage unit 101 as a storage unit. Also, during learning, the question-answering apparatus 10 includes an input unit 102, a word sequence vectorization unit 103, a word sequence matching unit 104, a style-dependent answer sentence generation unit 105, and a parameter learning unit 106 as functional components.

The word vector storage unit 101 stores data, each item of which represents a combination of a word and a word vector, which is the word expressed in vector form. A concrete example of the data stored in the word vector storage unit 101 will be described later.

The input unit 102 accepts input of a training data set made up of plural items of training data. The training data is used during learning of a neural network (answer sentence generating model) and is expressed by a combination of a question, a document set, an answer style, and an answer sentence, which provides a right answer (hereinafter the sentence is also referred to as a “right answer sentence”). Note that the training data may also be referred to as “learning data.”

Here, examples of training data include the following.
(Example 1) question: In what city the 2020 Olympics will be held?; document set: a set of news articles; answer style: “word”; right answer sentence: “Tokyo”
(Example 2) question: In what city the 2020 Olympics will be held?; document set: a set of news articles; answer style: “natural sentence”; right answer sentence: “The 2020 Olympics will be held in Tokyo.”

In this way, each item of training data contains a question, a document set, an answer style, and a right answer sentence according to the answer style. Note that it is sufficient that the document set includes at least one or more documents.

The word sequence vectorization unit 103 converts a word sequence of each document of a document set contained in each item of training data into a vector sequence (hereinafter also referred to as a “document vector sequence”). Also, the word sequence vectorization unit 103 converts the word sequence of a question contained in the training data into a vector sequence (hereinafter also referred to as a “question vector sequence”).

The word sequence matching unit 104 calculates a matching matrix between a document vector sequence and question vector sequence and then calculates a matching vector sequence using the matching matrix.

Using the answer style contained in the training data as well as the matching vector sequence, the style-dependent answer sentence generation unit 105 generates an answer sentence according to the answer style.

Using a loss (error) between the right answer sentence contained in the training data and generated answer sentence, the parameter learning unit 106 learns (updates) a parameter of a neural network (answer sentence generating model). Consequently, the neural network (answer sentence generating model) is learned. Note that to distinguish the parameter from a hyper parameter, the parameter to be learned is also referred to as a “learning parameter.”

<<During Question-Answering>>

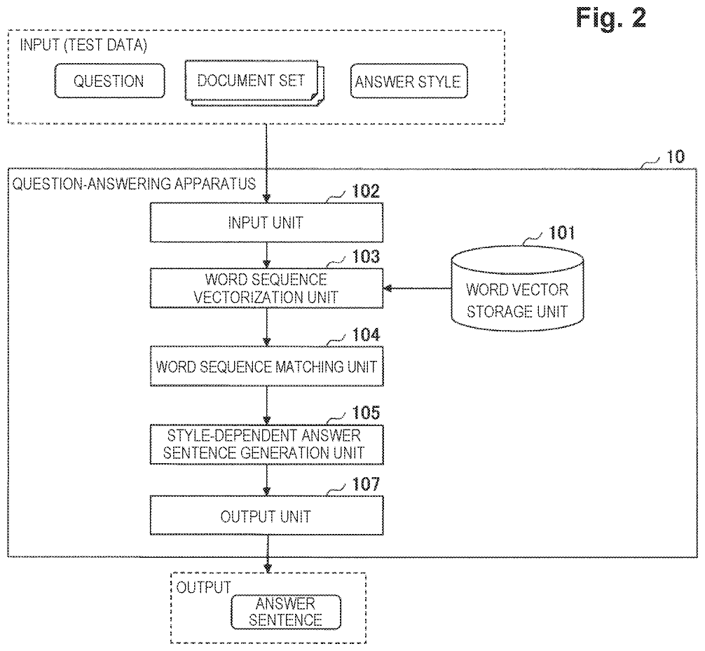

A functional configuration of the question-answering apparatus 10 according to the first embodiment of the present invention during question-answering will be described with reference to FIG. 2. FIG. 2 is a diagram showing an example of a functional configuration (during question-answering) of the question-answering apparatus 10 according to the first embodiment of the present invention.

As shown in FIG. 2, during question-answering, the question-answering apparatus 10 includes the word vector storage unit 101 as a storage unit. Also, during question-answering, the question-answering apparatus 10 includes the input unit 102, the word sequence vectorization unit 103, the word sequence matching unit 104, the style-dependent answer sentence generation unit 105, and the output unit 107 as functional components.

The word vector storage unit 101 stores data, each item of which represents a combination of a word and a word vector, which is the word expressed in vector form. A concrete example of the data stored in the word vector storage unit 101 will be described later.

The input unit 102 accepts input of test data. The test data is used during question-answering and is expressed by a combination of a question, a document set, and an answer style. Note that the test data may be called by another name such as “question data.”

The word sequence vectorization unit 103 converts a word sequence of each document of a document set contained in the test data into a document vector sequence. Also, the word sequence vectorization unit 103 converts the word sequence of a question contained in the test data into a question vector sequence.

The word sequence matching unit 104 calculates a matching matrix between a document vector sequence and question vector sequence and then calculates a matching vector sequence using the matching matrix.

Using the answer style contained in the test data as well as the matching vector sequence, the style-dependent answer sentence generation unit 105 generates an answer sentence according to the answer style.

The output unit 107 outputs a generated answer sentence. Note that the output destination of the answer sentence is not limited. For example, the output unit 107 may output (display) the answer sentence to (on) a display or the like, output (save) the answer sentence to (in) a storage device or the like, or output (transmit) the answer sentence to other devices connected via a communications network. Besides, the output unit 107 may convert the answer sentence, for example, into voice and output the voice through a speaker or the like.

<<Data Stored in Word Vector Storage Unit 101>>

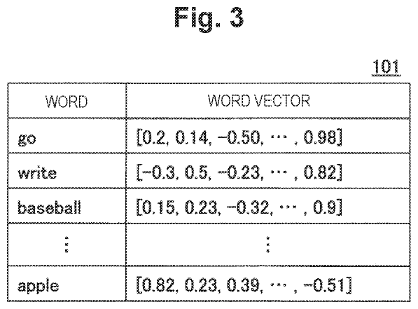

Here, an example of data stored in the word vector storage unit 101 is shown in FIG. 3. FIG. 3 is a diagram showing the example of data stored in the word vector storage unit 101.

As shown in FIG. 3, in the word vector storage unit 101, words such as “go,” “write,” and “baseball,” are associated with word vectors, which are the words expressed in vector form.

Also, in the word vector storage unit 101, special characters are associated with word vectors, which are the special words expressed in vector form. Examples of the special characters include “<PAD>,” “<UNK>,” “<S>,” and “</S>.”<PAD> is a special character used for padding. <UNK> is a special character used in converting a word not stored in the word vector storage unit 101 into a word vector. <S> and </S> are special characters inserted at the head and tail of a word sequence, respectively.

Here, the data stored in the word vector storage unit 101 is created, for example, by a method described in Reference 1 below. Also, it is assumed that the word vector of each word is v-dimensional. Note that the word vectors of special characters are also v-dimensional, and the word vectors of the special characters are learning parameters of neural networks (answer sentence generating models). The value of v can be set, for example, to v=300 or the like.

[Reference 1]
Jeffrey Pennington, Richard Socher, Christopher D. Manning, “Glove: Global Vectors for Word Representation,” EMNLP 2014, 1532-1543

<Hardware Configuration of Question-Answering Apparatus 10>

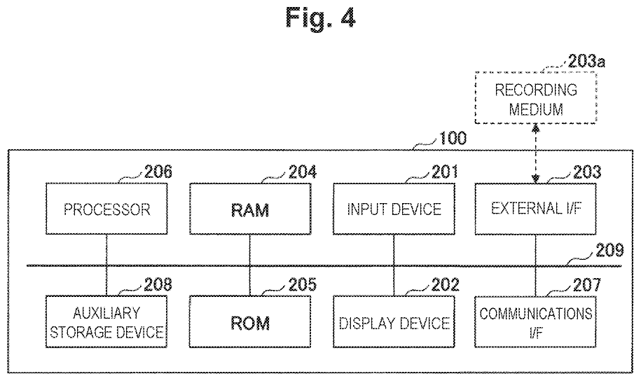

Next, a hardware configuration of the question-answering apparatus 10 according to the first embodiment of the present invention will be described with reference to FIG. 4. FIG. 4 is a diagram showing an example of the hardware configuration of the question-answering apparatus 10 according to the first embodiment of the present invention.

As shown in FIG. 4, the hardware configuration of the question-answering apparatus 10 according to the first embodiment of the present invention includes an input device 201, a display device 202, an external interface 203, a RAM (Random Access Memory) 204, a ROM (Read Only Memory) 205, a processor 206, a communications interface 207, and an auxiliary storage device 208 as hardware. These pieces of hardware are interconnected via a bus 209 in communication-ready state.

The input device 201 is, for example, a keyboard, a mouse, or a touch panel, and is used by a user to enter various operation inputs. The display device 202 is, for example, a display, and displays, for example, processing results (e.g., response to a question) of the question-answering apparatus 10. Note that the question-answering apparatus 10 does not need to have at least one of the input device 201 and display device 202.

The external interface 203 is an interface with an external device. Examples of the external device include a recording medium 203a. The question-answering apparatus 10 can read, and write into, the recording medium 203a via the external interface 203. One or more programs or the like that implement functional components of the question-answering apparatus 10 are recorded on the recording medium 203a.

Examples of the recording medium 203a include a flexible disk, a CD (Compact Disk), a DVD (Digital Versatile Disk), an SD memory card (Secure Digital memory card), and a USB (Universal Serial Bus) memory card.

The RAM 204 is a volatile semiconductor memory configured to temporarily hold programs and data. The ROM 205 is a nonvolatile semiconductor memory capable of holding programs and data even if power is turned off. The ROM 205 stores, for example, setting information about an OS (Operating System), setting information about a communications network, and other setting information.

The processor 206, which is, for example, a CPU (Central Processing Unit) or GPU (Graphics Processing Unit), reads a program or data from the ROM 205, auxiliary storage device 208, or the like into the RAM 204 and runs a process. Functional components of the question-answering apparatus 10 are implemented, for example, by processes run by the processor 206 according to one or more programs stored in the auxiliary storage device 208. Note that the question-answering apparatus 10 may have both or only one of CPU and GPU as the processor(s) 206.

The communications interface 207 is used to connect the question-answering apparatus 10 to a communications network. One or more programs that implement the functional components of the question-answering apparatus 10 may be acquired (downloaded) from a predetermined server device or the like via the communications interface 207.

The auxiliary storage device 208 is a nonvolatile storage device, such as an HDD (Hard Disk Drive) or SSD (Solid State Drive), configured to store programs and data. Examples of the programs and data stored in the auxiliary storage device 208 include an OS and various application programs as well as one or more programs that implement the functional components of the question-answering apparatus 10. Also, the word vector storage unit 101 of the question-answering apparatus 10 can be implemented using the auxiliary storage device 208. However, the word vector storage unit 101 of the question-answering apparatus 10 may be implemented using, for example, a storage device or the like connected to the question-answering apparatus 10 via a communications network.

By having the hardware configuration shown in FIG. 4, the question-answering apparatus 10 according to the first embodiment of the present invention can implement various processes described later. Note that although in the example shown in FIG. 4, the question-answering apparatus 10 according the first embodiment of the present invention is implemented by a single device (computer), this is not restrictive. The question-answering apparatus 10 may be implemented by plural devices (computers). Also, a single device (computer) may include plural processors 206 and plural memories (RAM 204, ROM 205, auxiliary storage device 208, etc.).

<Learning Process>

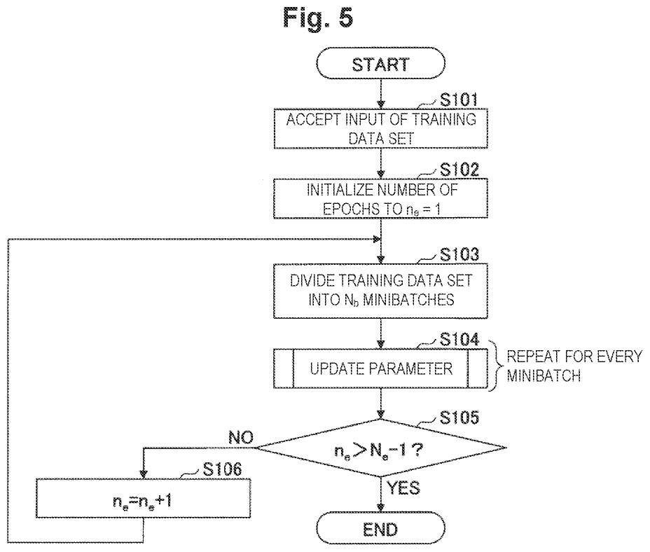

The process of learning an answer sentence generating model using the question-answering apparatus 10 according the first embodiment of the present invention (learning process) will be described below with reference to FIG. 5. FIG. 5 is a flowchart showing an example of a learning process according to the first embodiment of the present invention. Note that as described above, during learning, the question-answering apparatus 10 includes the functional components and storage unit shown in FIG. 1.

Step S101: The input unit 102 accepts input of a training data set. The input unit 102 may, for example, accept input of a training data set stored in the auxiliary storage device 208, recording medium 203a, or the like or acquired (downloaded) from a predetermined server device or the like via the communications interface 207.

Step S102: The input unit 102 initializes the number of epochs nₑ to 1, where the number of epochs nₑ represents the number of times the training data set is learned. Note that a maximum value of the number of epochs nₑ is denoted as Nₑ. Nₑ is a hyperparameter and can be set, for example, to Nₑ=15.

Step S103: The input unit 102 divide the training data set into N_{b} minibatches. Note that the number of divisions N_{b} into minibatches is a hyperparameter and can be set, for example, to N_{b}=60.

Step S104: The question-answering apparatus 10 runs a parameter update process repeatedly every one of the N_{b} minibatches. That is, the question-answering apparatus 10 calculates losses using the mini batches and then updates a parameter by any optimization method using the losses. Note that details of the parameter update process will be described later.

Step S105: The input unit 102 determines whether the number of epochs nₑ is larger than Nₑ−1. If it is not determined that the number of epochs nₑ is larger than Nₑ−1, the question-answering apparatus 10 runs the process of step S106. On the other hand, if it is determined that the number of epochs nₑ is larger than Nₑ−1, the question-answering apparatus 10 finishes the learning process.

Step S106: The input unit 102 increments the number of epochs nₑ by “1.” Then, the question-answering apparatus 10 runs the process of step S103. Consequently, the processes of steps S103 and 3104 are run repeatedly Nₑ times using the training data set inputted in step S101.

<Parameter Update Process>

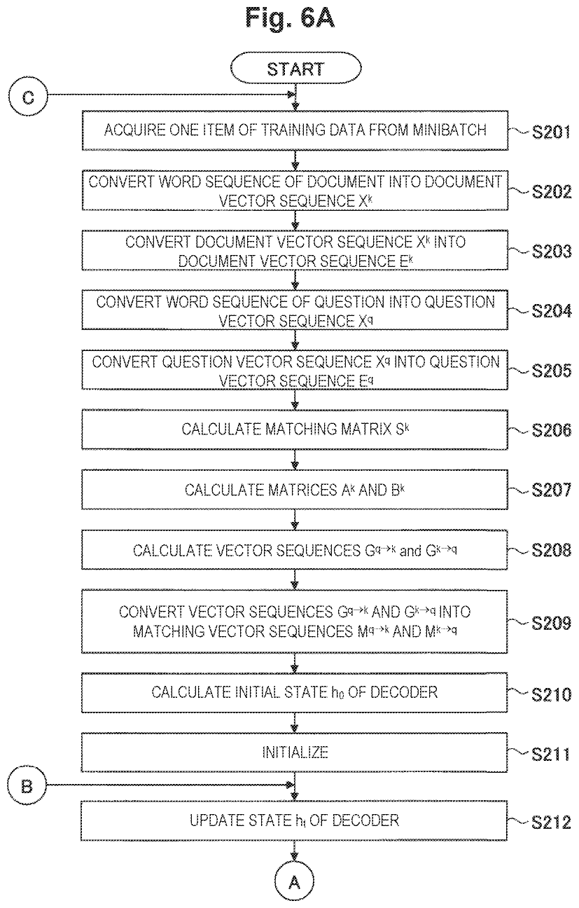

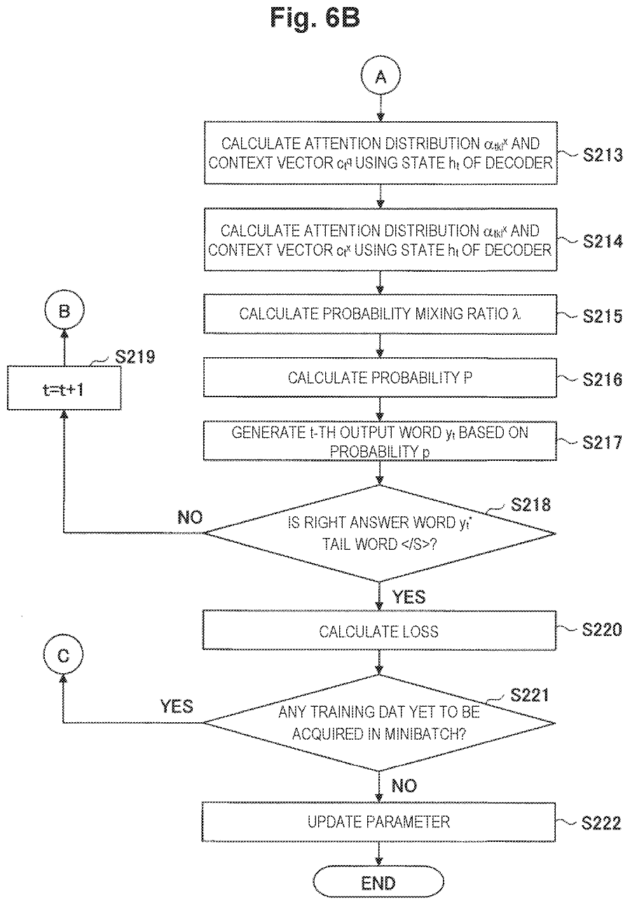

Here, details of the parameter update process in step S104 above will be described with reference to FIGS. 6A and 6B. FIGS. 6A and 6B are a flowchart showing an example of the parameter update process according to the first embodiment of the present invention. Note that description will be given below of a parameter update process performed using one of the N_{b} minibatches.

Step S201: The input unit 102 acquires one item of training data from the minibatch. Note that it is assumed below that the document set contained in the training data is made up of K documents.

Step S202: The word sequence vectorization unit 103 searches the word vector storage unit 101 for each word contained in the word sequence

[Math. 1]

(x₁^{k},x₂^{k}, . . . ,x_{L}^{k})

in the k-th document of the document set (k=1, . . . , K) contained in the training data, converts each word into a word vector, and thereby converts the word sequence in the k-th document into a document vector sequence as follows:

[Math. 2]

X^{k}=[X₁^{k},X₂^{k}, . . . ,X_{L}^{k}]∈R^{v×L}

where L is the length of the word sequence in the document and can be set, for example, to L=400.

In so doing, before converting the word sequence in the k-th document into a document vector sequence X^{k}, the word sequence vectorization unit 103 inserts a special character <S> at the head of the word sequence and inserts a special character </S> at the tail. Also, if the length of the word sequence with the special characters <S> and </S> inserted therein is smaller than L, the word sequence vectorization unit 103 pads the word sequence with a special character <PAD> such that the length of the word sequence will become equal to L. Furthermore, when converting a word not stored in the word vector storage unit 101 into a word vector, the word sequence vectorization unit 103 does so by treating the word as a special character <UNK>.

Step S203: Next, using a bidirectional GRU (Gated Recurrent Unit) described in Reference 2 below, the word sequence vectorization unit 103 converts the k-th document vector sequence X^{k} (k=1, . . . , K) into a document vector sequence

[Math. 3]

E^{k}=[E₁^{k},E₂^{k}, . . . ,E_{L}^{k}]∈R^{2d×L}

where d is hidden size of GRU, and can be set, for example, to d=100.

[Reference 2]
Kyunghyun Cho, Bart van Merrienboer, Caglar Gulcehre, Dzmitry Bahdanau, Fethi Bougares, Holger Schwenk, Yoshua Bengio, “Learning Phrase Representations using RNN Encoder-Decoder for Statistical Machine Translation,” EMNLP 2014: 1724-1734

Step S204: The word sequence vectorization unit 103 searches the word vector storage unit 101 for each word contained in the word sequence of a question contained in the training data,

[Math. 4]

(x₁^{q},x₂^{q}, . . . ,x_{J}^{q})

converts each word into a word vector, and thereby converts the word sequence of the question into a question vector sequence

[Math. 5]

X^{q}=[X₁^{q},X₂^{q}, . . . ,Xⱼ^{q}]∈R^{v×J}

where J is the length of the word sequence of the question, and can be set, for example, to J=30. Note that in so doing, the word sequence vectorization unit 103 uses special characters <S>, </S>, <PAD>, and <UNK> as in step S202 above.

Step S205: Next, using the bidirectional GRU described in Reference 2 as in step S203 above, the word sequence vectorization unit 103 converts a question vector sequence X^{q} into a question vector sequence

[Math. 6]

E^{q}=[E₁^{q},E₂^{q}, . . . ,E_{J}^{q}]∈R^{2d×J}

Hereinafter it is assumed that a vector obtained by connecting a vector made up of d-dimensional elements corresponding to a backward GRU out of the elements of E₁^{q}∈R₂^{d} with a vector made up of d-dimensional elements corresponding to a forward GRU out of the elements of E_{J}^{q} ∈R₂^{d} is as follows:

[Math. 7]

Eₗₐₛₜ^{q}

Step S206: Next, the word sequence matching unit 104 calculates elements of (l, j) components of a matching matrix S′ between a document vector sequence E^{k} (where k=1, . . . , K) and question vector sequence using Expression (1) below.

[Math. 8]

Sₗⱼ^{k}=w_{S}^{τ}[Eₗ^{k};Eⱼ^{q};Eₗ^{k}⊙Eⱼ^{q}]∈R (1)

where

[Math. 9]

⊙

indicates the products of vectors on an element by element basis (Hadamard product), “;” indicates a connection of vectors, and τ indicates transposition. Also, wₛ∈R^{6d} is a learning parameter of an answer sentence generating model.

Step S207: Next, the word sequence matching unit 104 calculates matrices A^{k} and B^{k} (where k=1, . . . , K) using a matching matrix S^{k} by means of Expressions (2) and (3) below.

[Math. 10]

A^{k}=softmax(S^{k}^{^{τ}})∈R^{J×L} (2)

B^{k}=softmax(S^{k})∈R^{L×J} (3)

Step S208: Next, the word sequence matching unit 104 calculates vector sequences G^{q→k} and G^{k→q} using the document vector sequence E^{k}, question vector sequence E^{q}, and matrices A^{k} and B^{k} by means of Expressions (4) and (5) below.

[Math. 11]

G^{q→k}=[E^{k};Ē^{q};E^{k}⊙Ē^{q};E^{k}⊙E̅^{k};]∈R^{8d×L} (4)

G^{k→q}=[E^{q};Ē^{k};E^{q}⊙Ē^{k};E^{q}⊙E̅^{q};]∈R^{8d×j} (5)

where the following expressions hold.

$$\begin{matrix}{\overline{E}}^{q} = {E}^{q} {A}^{k} ∈ {R}^{2 d \times L} & {\overline{\overline{E}}}^{q} = {max}_{k} ( {E}^{q} {B}^{k} ) ∈ {R}^{2 d \times J} \\ {\overline{E}}^{k} = {max}_{k} ( {E}^{k} {B}^{k} ) ∈ {R}^{2 d \times J} & {\overline{\overline{E}}}^{k} = {\overline{E}}^{k} {A}^{k} ∈ {R}^{2 d \times L}\end{matrix} \qquad [ Math . 12 ]$$

Note that G^{k→q} is calculated only once and G^{q→k} is calculated every document (i.e., G^{q→k} is calculated for every k (k=1, . . . , K)).

Step S209: Next, using one layer of bidirectional GRU (hidden size d), the word sequence matching unit 104 converts the vector sequences G^{q→k} and G^{k→q} into matching vector sequences M^{q→k}∈R^{2d×L} and M^{k→q}∈R^{2d×J}, restrictively.

Step S210: Next, the style-dependent answer sentence generation unit 105 calculates an initial state h₀∈R^{2d} of a decoder using Expression (6) below.

[Math. 13]

h₀=tanh(WEₗₐₛₜ^{q}+b)∈R^{2d} (6)

where W∈R^{2d×2d} and b∈R^{2d} are learning parameters of an answer sentence generating model.

Step S211: Next, the style-dependent answer sentence generation unit 105 uses the special character <S> as an output word y₀ and initializes an index t of an output word yₜ to t=1. Also, the style-dependent answer sentence generation unit 105 initializes a question context vector c₀^{q} and document set context vector c₀^{x} to respective 2d-dimensional zero vectors.

Step S212: Next, the style-dependent answer sentence generation unit 105 updates a state hₜ of the decoder using a unidirectional GRU. That is, the style-dependent answer sentence generation unit 105 updates the state hₜ of the decoder using Expression (7) below.

[Math. 14]

hₜ=GRU(hₜ₋₁,[Yₜ₋₁;cₜ₋₁^{q};cₜ₋₁^{x};z])∈R (7)

where Yₜ₋₁ is a v-dimensional word vector converted from an output word yₜ₋₁ at the immediately preceding index t−1 based on data stored in the word vector storage unit 101. Also, z is a one-hot vector of dimension equal to the number of answer styles, and only elements having a specified answer style (i.e., the answer style contained in the given training data) take a value of 1, but other elements take 0. For example, when there are two answer styles, “word” and “natural sentence,” z is a two-dimensional vector.

Step S213: Next, using the state hₜ of the decoder, the style-dependent answer sentence generation unit 105 calculates an attention distribution αₜⱼ^{q} on a question and a question context vector cₜ^{q} by means of Expressions (8) to (10) below.

$$\begin{matrix}[ Math . 15 ] & \\ {e}_{tj} = S ( {M}_{j}^{q} , {h}_{t} ) ∈ R & ( 8 ) \\ {α}_{tj}^{q} = \frac{{e}_{tj}}{{\sum }_{{j}^{′} = 1}^{J} {e}_{{tj}^{′}}} & ( 9 ) \\ {c}_{t}^{q} = {\sum }_{j = 1}^{J} {α}_{tj}^{q} {M}_{j}^{q} & ( 10 )\end{matrix}$$

where, Mⱼ^{q} is the j-th column vector of M^{k→q}∈R^{2d×J}. Also, S is a score function and, for example, an inner product can be used for it. Note that other than an inner product, for example, a bilinear, multilayered, or other perceptron may be used as the score function S.

Step S214: Next, using the state hₜ of the decoder, the style-dependent answer sentence generation unit 105 calculates an attention distribution αₜₖₗ^{x} on a document set and a document context vector cₜ^{k} by means of Expressions (11) to (13) below. PGP-22X

$$\begin{matrix}[ Math . 16 ] & \\ {e}_{tkl} = S ( {M}_{l}^{k} , {h}_{t} ) ∈ R & ( 11 ) \\ {α}_{tkl}^{x} = \frac{{e}_{tkl}}{{\sum }_{{k}^{′} = 1}^{J} {e}_{{tk}^{′} {l}^{′}}} & ( 12 ) \\ {c}_{t}^{x} = {\sum }_{k = 1}^{K} {\sum }_{l = 1}^{L} {α}_{tkl}^{x} {M}_{j}^{k} & ( 13 )\end{matrix}$$

where, Mₗ^{q} is the l-th column vector of M^{q→k}∈R^{2d×L}. Note that an inner product can be used for the score function S, but as described above, for example, a bilinear, multilayered, or other perceptron may be used as the score function S.

Step S215: Next, the style-dependent answer sentence generation unit 105 calculates a probability combination ratio λ using Expression (14) below.

[Math. 17]

λ=softmax(W^{λ}[hₜ;cₜ^{q};cₜ^{x}]+b^{λ})∈R³ (14)

where W^{λ}∈R^{3×5d} and b^{λ}∈R³ are learning parameters of an answer sentence generating model.

The probability combination ratio λ is a parameter used to adjust which of a question, a document set, and a preset output vocabulary, importance is to be attached to in generating the output word yₜ. Hereinafter the probability combination ratio λ will be expressed as λ=[λ1, λ2, λ3]τ. Note that the output vocabulary is a set of words available for use in answer sentences. The volume of output vocabulary (i.e., the number of output words) is denoted as Vout.

Step S216: Next, using the probability mixing ratio λ, the style-dependent answer sentence generation unit 105 calculates probability p of generating the word yₜ, by means of Expression (15) below.

[Math. 18]

P(yₜ|y<_{<t})=λ₁P_{C}^{x}(yₜ|y_{<t})+λ₂P_{C}^{x}(yₜ|Y_{<t})+λ₃P_{G}(yₜ|y_{<t}) (15)

Now, by assuming that

$$\begin{matrix}[ Math . 19 ] & \\ {P}_{C}^{q} ( {y}_{t} \vert {y}_{< t} ) = \{ \begin{matrix}{\sum }_{j = 1}^{J} {α}_{tj}^{q} & if {y}_{t} = {x}_{j}^{q} \\ 0 & otherwise\end{matrix} \\ {P}_{C}^{x} ( {y}_{t} \vert {y}_{< t} ) = \{ \begin{matrix}{\sum }_{k = 1}^{K} {\sum }_{l = 1}^{L} {α}_{tkl}^{x} & if {y}_{t} = {x}_{l}^{k} \\ 0 & otherwise\end{matrix} & \end{matrix}$$

the attention distribution on the document and attention distribution on a word are used. Also, the probability P_{G} of a word in the set output vocabulary is calculated by the follows expression.

[Math. 20]

P_{G}(yₜ|y_{<t})=softmax(W₂σ(W₁[hₜ;cₜ^{q};cₜ^{x}]+b₁)+b₂)

where

[Math. 21]

W₁∈R^{v×5d}b₁∈R^{v}

W₂∈R^{V}^{ₒᵤₜ}^{×v}b₂∈R^{V}^{ₒᵤₜ}

is a learning parameter of an answer sentence generating model. Also, σ is an activation function, and, for example, ReLU is used.

Step S217: Next, the style-dependent answer sentence generation unit 105 generates the t-th output word yₜ based on the probability p of generation calculated using Expression (15) above. Here, the style-dependent answer sentence generation unit 105 may generate, for example, a word that maximizes the probability p of generation, as the output word yₜ or generate a word as the output word yₜ by sampling according to a distribution of the probability p of generation (probability distribution).

Step S218: Next, the style-dependent answer sentence generation unit 105 determines whether the t-th word of the right answer sentence contained in the training data is a special word </S> (i.e., a special word that indicates the tail). If it is determined that the t-th word of the right answer sentence is not </S>, the question-answering apparatus 10 runs the process of step S219. On the other hand, if it is determined that the t-th word of the right answer sentence is </S>, the question-answering apparatus 10 runs the process of step S220.

Step S219: The style-dependent answer sentence generation unit 105 increments the index t of the output word yₜ by “1.” Then, the style-dependent answer sentence generation unit 105 runs the process of step S212 using t after the increment. Consequently, the processes of steps S212 and S17 are run repeatedly until the t-th word of the right answer sentence becomes </S> for every t (t=1, 2, . . . ).

Step S220: Using the output word yₜ generated in step S217 and the right answer sentence, the parameter learning unit 106 calculates a loss L_{G} by means of Expression (16) below.

$$\begin{matrix}[ Math . 22 ] & \\ {L}_{G} = - \frac{1}{T} {\sum }_{t} ln ( p ( {y}_{t}^{*} \vert {y}_{< t} ) ) & ( 16 )\end{matrix}$$

where yₜ* is the t-th word of the right answer sentence (i.e., the t-th right answer word). Also, T is the length of the right answer sentence. Consequently, the loss L_{G} in one item of the training data is calculated.

Step S221: Next, the input unit 102 determines whether there is any training data yet to be acquired in the minibatch. If it is determined that there is any training data yet to be acquired in the minibatch, the question-answering apparatus 10 runs the process of step S201. Consequently, the processes of steps S202 to S220 are run for each item of training data contained in the minibatch. On the other hand, if it is determined that there is no training data yet to be acquired in the minibatch (i.e., if the processes of steps S202 and S220 have been run for all the training data contained in the minibatch), the question-answering apparatus 10 runs the process of step S222.

Step S222: The parameter learning unit 106 calculates the average of the losses L_{G} calculated for the respective items of training data contained in the minibatch, and then updates the learning parameter of the answer sentence generating model (neural network), for example, by a stochastic gradient descent method using the calculated average. Note that the stochastic gradient descent method is an example of a parameter optimization method and the learning parameter may be updated by any optimization method. Consequently, the learning parameter of the answer sentence generating model is updated using one minibatch.

Note that although the output word yₜ is generated in step S217 above, it is not strictly necessarily to generate the output word yₜ. The loss L_{G} shown in Expression (16) above may be calculated without generating the output word yₜ.

<Question-Answering Process>

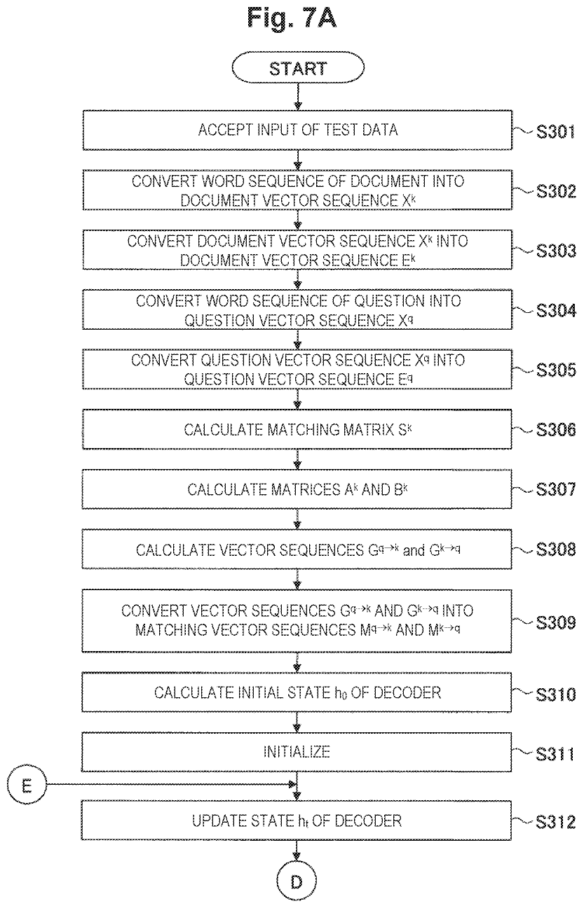

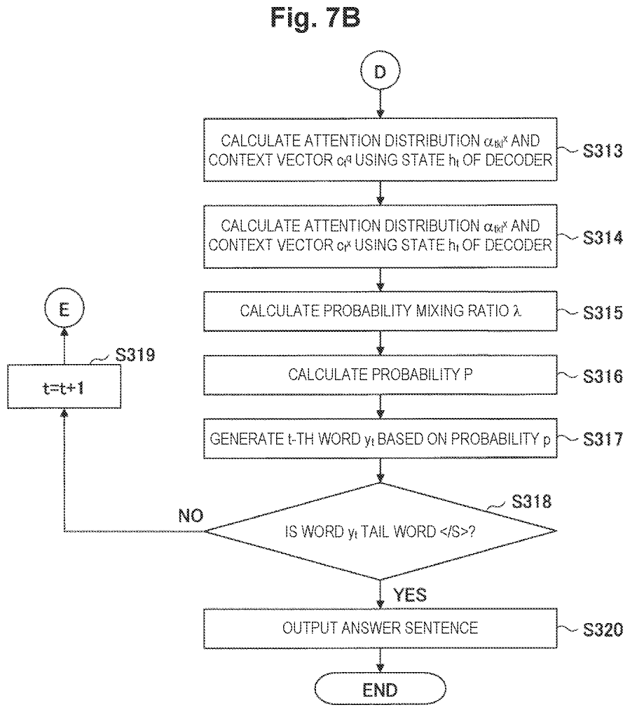

The process of question-answering performed by the question-answering apparatus 10 according the first embodiment of the present invention (question-answering process) will be described below with reference to FIG. 7. FIGS. 7A and 7B are a flowchart showing an example of a question-answering process according to the first embodiment of the present invention. Note that as described above, during question-answering, the question-answering apparatus 10 includes the functional components and storage unit shown in FIG. 2.

Step S301: The input unit 102 acquires test data. Note that it is assumed below that a document set contained in the test data is made up of K documents.

The processes of steps S302 to S317 and S319 are similar to those of steps S202 to S217 and S219, respectively, and thus description thereof will be omitted. However, in the processes of steps S302 to S317 and S319, the question, document set, and answer style contained in the test data inputted in step S301 above are used. Also, as the parameter of the answer sentence generating model (neural network), the parameter learned in the learning process is used.

Step S318: The style-dependent answer sentence generation unit 105 determines whether the output word yₜ generated in step S317 is a special word </S> (i.e., a special word that indicates the tail). If it is determined that the output word yₜ is not a special word </S>, the question-answering apparatus 10 runs the process of step S319. On the other hand, if it is determined that the output word yₜ is a special word </S>, the question-answering apparatus 10 runs the process of step S320.

Step S320: The output unit 107 outputs an answer sentence made up of the output words yₜ generated in step S317. Consequently, an answer sentence according to the answer style contained in the test data is obtained as an answer sentence for the question contained in the test data.

<Experimental Results According to the First Embodiment of the Present Invention>

Here, experimental results according to the first embodiment of the present invention is shown in Table 1 below (hereinafter also referred to as a “technique of the present invention”).

TABLE 1

| Model | Rouge-L | Bleu-1 |
|---|---|---|
| Technique of present invention | 69.77 | 65.56 |
| w/o multi-style learning | 68.20 | 63.95 |

where as experimental data, of data included in Dev Set of MS MARCO v.2.1, data containing answerable questions and natural answer sentences was used. Also, as evaluation indices, Rouge-L and Bleu-1 were used. In Table 1 above, “w/o multi-style learning” indicates a technique (conventional technique) for generating answer sentences without regard for answer styles.

As shown in Table 1 above, with the technique of the present invention, values higher than with the conventional technique are obtained in terms of both Rouge-L and Bleu-1. Therefore, it can be seen that the technique of the present invention provides a normal answer sentence according to an answer style in response to a given question. Thus, the technique of the present invention allows an answer sentence according to a given answer style to be obtained with higher accuracy than the conventional technique that outputs an answer sentence according to a certain answer style.

### Second Embodiment

Generally, it is often the case that a document set given to the question-answering apparatus 10 contains both documents suitable for generating an answer sentence and documents unsuitable for generating an answer sentence. There is also a case in which a document set as a whole is inadequate for generating an answer sentence. Whether or not individual documents are suitable for generating answer sentences and whether or not the entire document set is adequate for generating answer sentences are closely related to accuracy and the like of the generated answer sentences.

Thus, in the second embodiment, description will be given of a question-answering apparatus 10, which when provided with any document set, any question to the document set, and an answer style specified, for example, by a user, not only generates an answer sentence according to the answer style, but also outputs document fitness that represents goodness of fit of each document to generation of an answer sentence and answerableness that represents adequacy of the entire document set to generate the answer sentence using a sentence generation technique based on a neural network.

Note that in the second embodiment, differences from the first embodiment will be described mainly, and description of the same components as those of the first embodiment will be omitted or simplified as appropriate.

<Functional Configuration of Question-Answering Apparatus 10>

<<During Learning>>

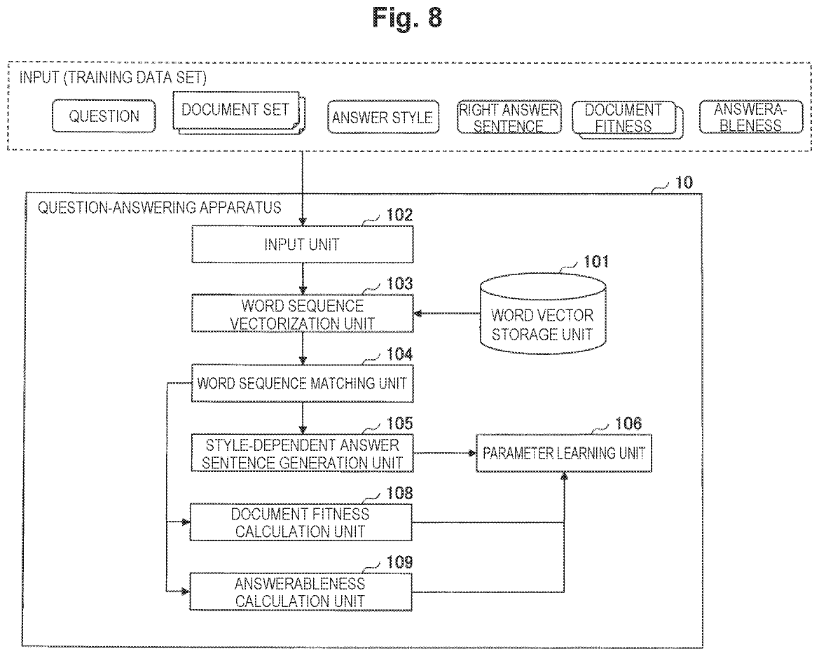

A functional configuration of the question-answering apparatus 10 according to the second embodiment of the present invention during learning will be described with reference to FIG. 8. FIG. 8 is a diagram showing an example of the functional configuration (during learning) of the question-answering apparatus 10 according to the second embodiment of the present invention.

As shown in FIG. 8, during learning, the question-answering apparatus 10 includes the word vector storage unit 101 as a storage unit. During learning, the question-answering apparatus 10 also includes the input unit 102, the word sequence vectorization unit 103, the word sequence matching unit 104, the style-dependent answer sentence generation unit 105, the parameter learning unit 106, a document fitness calculation unit 108, and an answerableness calculation unit 109 as functional components.

According to the second embodiment, it is assumed that the training data is expressed by a combination of a question, a document set, an answer style, a right answer sentence, document fitness of each document contained in the document set, and answerableness of the entire document. The document fitness is an index value that represents the goodness of fit of the document to generation of an answer sentence, and takes a value, for example, between 0 and 1, both inclusive. Also, the answerableness is an index value that represents adequacy of the entire document set to generate the answer sentence, and takes a value, for example, between 0 and 1, both inclusive. Note that the document fitness and answerableness contained in the training data are also referred to as “right document fitness” and “right answer ability,” respectively.

The document fitness calculation unit 108 calculates the document fitness of each document contained in the document set. The answerableness calculation unit 109 calculates the answerableness of the entire document.

Also, the parameter learning unit 106 learns (updates) a parameter of a neural network (answer sentence generating model) using a loss (error) between the right answer sentence contained in the training data and generated answer sentence, a loss (error) between the right document fitness contained in the training data and calculated document fitness, and a loss (error) between the right answer ability contained in the training data and calculated answerableness. Consequently, the neural network (answer sentence generating model) is learned.

Here, according to the second embodiment, a neural network used to calculate the matching matrix S^{k} between the document vector sequence E^{k} and question vector sequence E^{q} is shared among the style-dependent answer sentence generation unit 105, document fitness calculation unit 108, and answerableness calculation unit 109. Consequently, the answer sentence generating model after learning allows the answer sentence, document fitness, and answerableness to be generated and outputted with high accuracy.

<<During Question-Answering>>

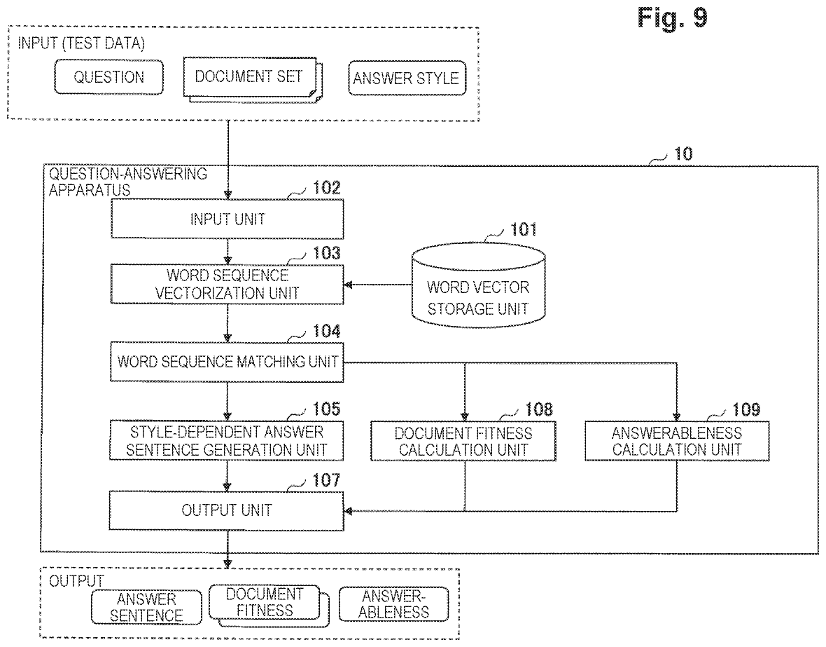

A functional configuration of the question-answering apparatus 10 according to the second embodiment of the present invention during question-answering will be described with reference to FIG. 9. FIG. 9 is a diagram showing an example of the functional configuration (during question-answering) of the question-answering apparatus 10 according to the second embodiment of the present invention.

As shown in FIG. 9, during question-answering, the question-answering apparatus 10 includes the word vector storage unit 101 as a storage unit. Also, during question-answering, the question-answering apparatus 10 includes the input unit 102, the word sequence vectorization unit 103, the word sequence matching unit 104, the style-dependent answer sentence generation unit 105, the output unit 107, the document fitness calculation unit 108, and the answerableness calculation unit 109, as functional components. Note that these storage unit and functional components are as described above.

<Learning Process>

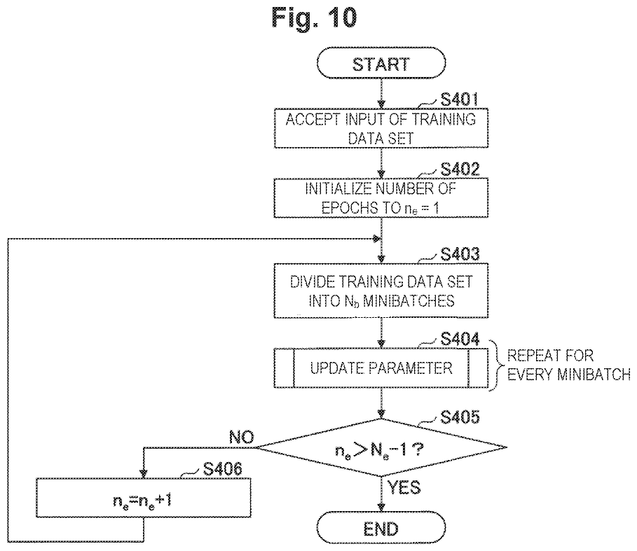

The process of learning an answer sentence generating model using the question-answering apparatus 10 according the second embodiment of the present invention (learning process) will be described below with reference to FIG. 10. FIG. 10 is a flowchart showing an example of the learning process according to the second embodiment of the present invention. Note that as described above, during learning, the question-answering apparatus 10 includes the functional components and storage unit shown in FIG. 8. Steps S401 to S406 in FIG. 10 are similar to those of steps S101 to S106 in FIG. 5, respectively, and thus description thereof will be omitted. However, details of a parameter update process in step S404 differ from step S104.

<Parameter Update Process>

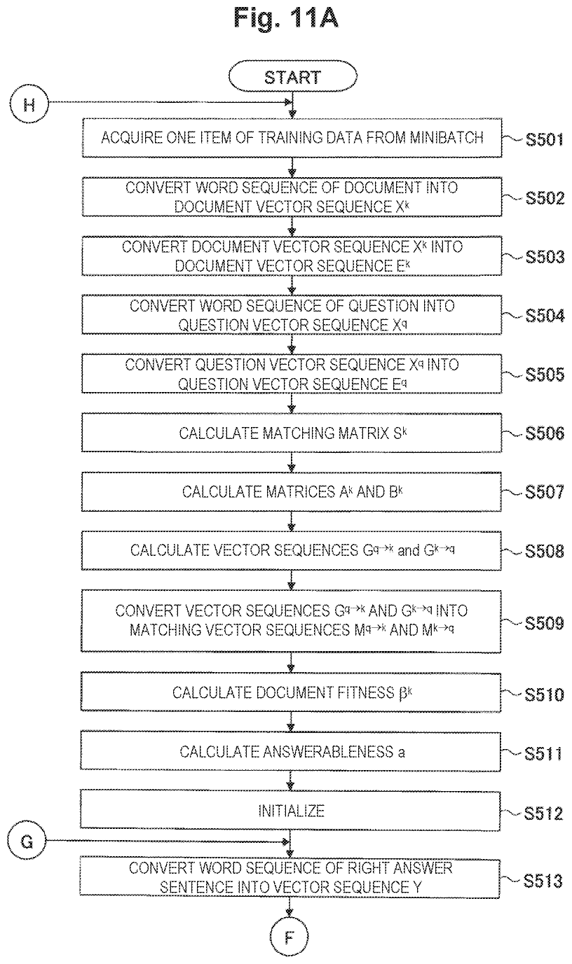

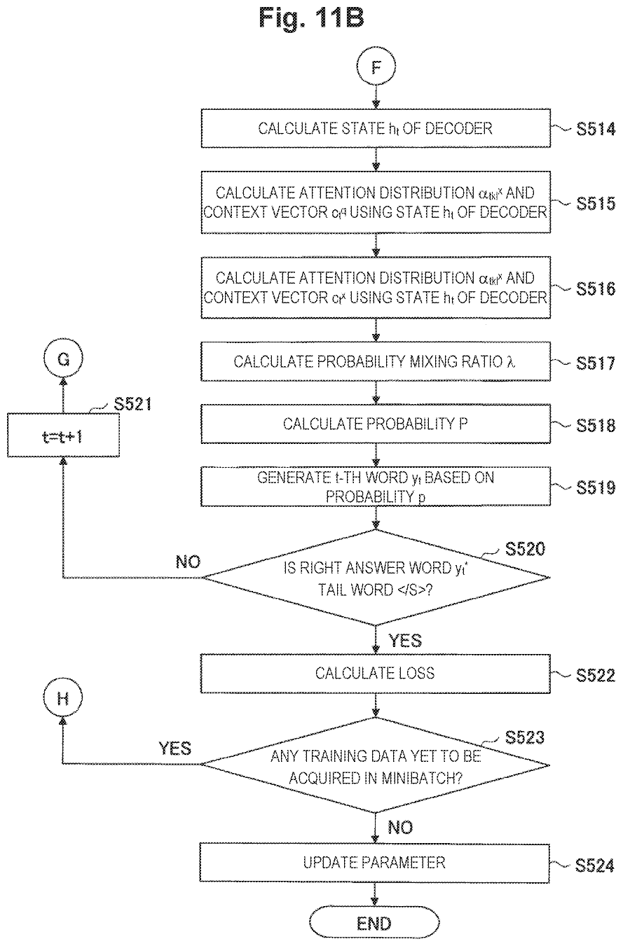

Thus, details of the parameter update process in step S404 above will be described with reference to FIGS. 11A and 11B. FIGS. 11A and 11B are a flowchart showing an example of the parameter update process according to the second embodiment of the present invention. Note that description will be given below of a parameter update process performed using one of N_{b} minibatches.

Step S501: The input unit 102 acquires one item of training data from the minibatch. Note that it is assumed below that the document set contained in the training data is made up of K documents.

Step S502: The word sequence vectorization unit 103 converts the word sequence in the k-th document into a document vector sequence X^{k} (k=1, . . . , K) as in step S202 above.

Step 3503: Next, using the bidirectional GRU described in Reference 2, the word sequence vectorization unit 103 converts the k-th document vector sequence X^{k} into a document vector sequence E^{k} (k=1, . . . , K), as in step S203 above.

Note that the word sequence vectorization unit 103 may convert the document vector sequence X^{k} into the document vector sequence E^{k} using, for example, LSTM (Long short-term memory) described in Reference 3 below or Transformer described in Reference 4 below instead of the bidirectional GRU.

[Reference 3]
Sepp Hochreiter and Jurgen Schmidhuber. 1997, “Long Short-Term Memory,” Neural Computation 9, 8 (1997), 1735-1780

[Reference 4]
Ashish Vaswani, Noam Shazeer, Niki Parmar, Jakob Uszkoreit, Llion Jones, Aidan N. Gomez, Lukasz Kaiser, Illia Polosukhin, “Attention is All you Need,” NIPS 2017: 6000-6010

Step 3504: The word sequence vectorization unit 103 converts the word sequence of a question into a question vector sequence X^{q} as in step S204 above.

Step S505: Next, as in step S203 above, the word sequence vectorization unit 103 converts the question vector sequence X^{q} into the question vector sequence E^{q} using the bidirectional GRU described in Reference 2.

Note that as in step S503 above, the word sequence vectorization unit 103 may convert the question vector sequence X^{q} into the question vector sequence E^{q} using, for example, LSTM described in Reference 3 or Transformer described in Reference 4 instead of the bidirectional GRU.

The processes of steps 3506 to 3508 below are similar to those of steps S206 to S208 above, respectively, and thus description thereof will be omitted.

Step 3509: As in step S209 above, the word sequence matching unit 104 converts the vector sequences G^{q→k} and G^{k→q} into matching vector sequences M^{q→k}∈R^{2d×L} and M^{k→q}∈R^{2d×J}, restrictively, using one layer of bidirectional GRU (hidden size d).

Note that the word sequence matching unit 104 may convert the vector sequences G^{q→k} and G^{k→q} into matching vector sequences M^{q→k}∈R^{2d×L} and M^{k→q}∈R^{2d×J}, restrictively, using, for example, LSTM described in Reference 3 or Transformer described in Reference 4 instead of one layer of bidirectional GRU.

Step S510: The document fitness calculation unit 108 calculates document fitness β^{k}∈[0, 1] of each document using Expression (17) below.

[Math. 23]

β^{k}=sigmoid(w^{rank}^{^{τ}}M^{k,pool}) (17)

where M^{k-pool}∈R^{2d} is pooling representation of the k-th document. Also, w^{rank}∈R^{2d} is a learning parameter of an answer sentence generating model. As the pooling representation M^{k-pool}, for example, a vector obtained by connecting tail vectors of bidirectional GRU of M^{k→q}, a head vector of Transformer, and the like are available for use.

Step S511: The answerableness calculation unit 109 calculates answerableness a ∈[0, 1] of the document set to the question using Expression (18) below.

[Math. 24]

P(a)=sigmoid(w^{ans}^{^{τ}}[M^{1,pool}, . . . ,M^{K,pool}]) (18)

where w^{ans}∈R^{2Kd} is a learning parameter of the answer sentence generating model.

Step S512: As in step S211 above, the style-dependent answer sentence generation unit 105 uses the special character <S> as an output word y₀ and initializes the index t of the output word yₜ to t=1. Also, the style-dependent answer sentence generation unit 105 initializes a question context vector c₀^{q} and document set context vector c₀^{x} to respective 2d-dimensional zero vectors.

Step S513: Next, the word sequence vectorization unit 103 searches the word vector storage unit 101 for each word contained in the word sequence (y₁, y₂, . . . , y_{T}) of a right question contained in the training data, converts each word into a word vector, and thereby converts the word sequence into a vector sequence Y=[Y₁, Y₂, . . . , Y_{T}]∈R^{v×T}.

In so doing, before converting the word sequence (y₁, y₂, . . . , y_{T}) into a vector sequence Y, the word sequence vectorization unit 103 inserts a special character at the head of the word sequence according to a specified answer style (i.e., the answer style contained in the given training data) and inserts a special character </S> at the tail. Suppose, for example, there are two answer styles, “word” and “natural sentence,” the special character for “word” is <E>, and the special character for “natural sentence” is <A>. In this case, if the specified answer style is “natural sentence,” the word sequence vectorization unit 103 inserts the special character <A> at the head of the word sequence. On the other hand, if the specified answer style is “word,” the word sequence vectorization unit 103 inserts the special character <E> at the head of the word sequence.

Also, when converting a word not stored in the word vector storage unit 101 into a word vector, the word sequence vectorization unit 103 does so by treating the word as a special character <UNK>. Note that according to the second embodiment, the word vector storage unit 101 stores data associating special characters according to answer styles with the word vectors of the special characters.

Step S514: Next, the style-dependent answer sentence generation unit 105 calculates the state h=[h₁, h₂, . . . , h_{T}]∈R^{2d×T} of the decoder. The style-dependent answer sentence generation unit 105 calculates the state h of the decoder using Transformer block processing. The Transformer block processing uses MaskedSelfAttention, MultiHeadAttention, and FeedForwardNetwork described in Reference 4. That is, the style-dependent answer sentence generation unit 105 calculates the state h of the decoder using Expressions (19) to (22) below after calculating M^{a}=W^{dec}Y.

[Math. 25]

M^{a}=MaskedSelfAttention(M^{a}) (19)

M^{a}=MultiHeadAttention(query=M^{a},key&value=M^{k→q}) (20)

M^{a}=MultiHeadAttention(query=M^{a},key&value=[M^{q→1}; . . . ;M^{q→K}]) (21)

h=FeedForwardNetwork(M^{a}) (22)

where w^{dec}∈R^{2d×v} is a learning parameter of the answer sentence generating model. Consequently, a state h∈R^{2d×T} of the decoder is obtained. Note that using Expressions (19) to (22) above as one block, the style-dependent answer sentence generation unit 105 may run block processing repeatedly.

Note that in the parameter update process, it is sufficient that step 3514 above is run once for one item of training data (i.e., it is not necessary to run step S514 above repeatedly for every index t).

The processes of steps 3515 to 3521 below are similar to those of steps S213 to S219 above, respectively, and thus description thereof will be omitted.

Step S522: Using the output word yₜ, a right answer sentence, the document fitness βₖ, right document fitness, the answerableness a, and right answer ability, the parameter learning unit 106 calculates the loss L by means of Expression (23) below.

[Math. 26]

L=L_{dec}+λᵣₐₙₖLᵣₐₙₖ+λ_{cls}L_{cls} (23)

where L_{G} is calculated using Expression (24) below.

$$\begin{matrix}[ Math . 27 ] & \\ {L}_{G} = - \frac{a}{T} {\sum }_{t} ln ( p ( {y}_{t}^{*} \vert {y}_{< t} ) ) & ( 24 )\end{matrix}$$

where Lᵣₐₙₖ is calculated using Expression (25) below.

$$\begin{matrix}[ Math . 28 ] & \\ {L}_{rank} = - \frac{1}{K} {\sum }_{k} {r}_{k} log {β}_{k} + ( 1 - {r}_{k} ) log ( 1 - {β}_{k} ) & ( 25 )\end{matrix}$$

where rₖ is the right document fitness of the k-th document.

Also, L_{cls} is calculated using Expression (26) below.

[Math. 29]

L_{cls}=−a logP(a)−(1−a)log(1−P(a)) (26)

Note that λᵣₐₙₖ and λ_{cls} in Expression (23) above are parameters set by the user, and possible settings are, for example, λᵣₐₙₖ=0.5, λ_{cls}=0.1, or the like.

The processes of steps S523 and S524 below are similar to those of steps S221 and S222 above, respectively, and thus description thereof will be omitted. Consequently, the learning parameter of the answer sentence generating model is updated using one minibatch.

Note that as with the first embodiment, it is not strictly necessarily to generate the output word yₜ in step S519 above. The loss L shown in Expression (23) above may be calculated without generating the output word yₜ.

<Question-Answering Process>

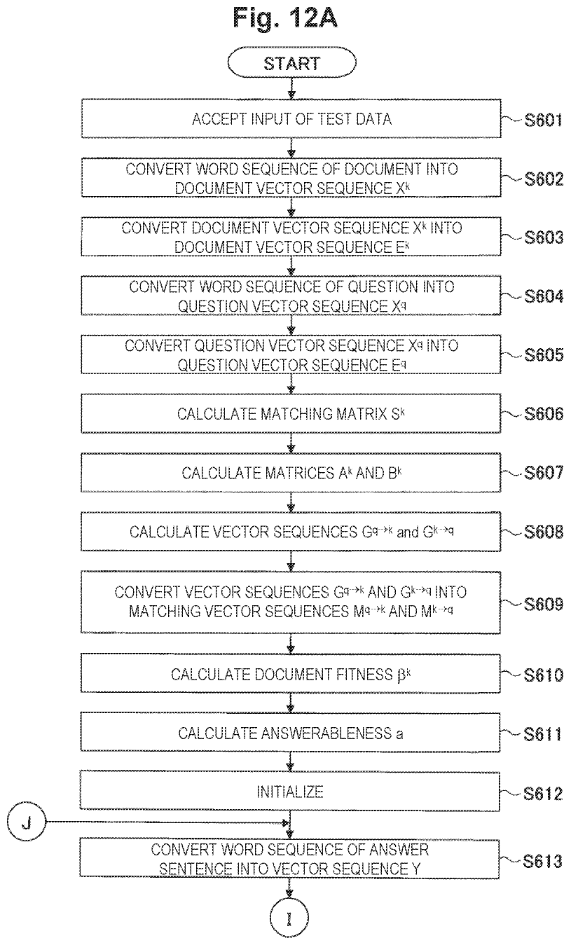

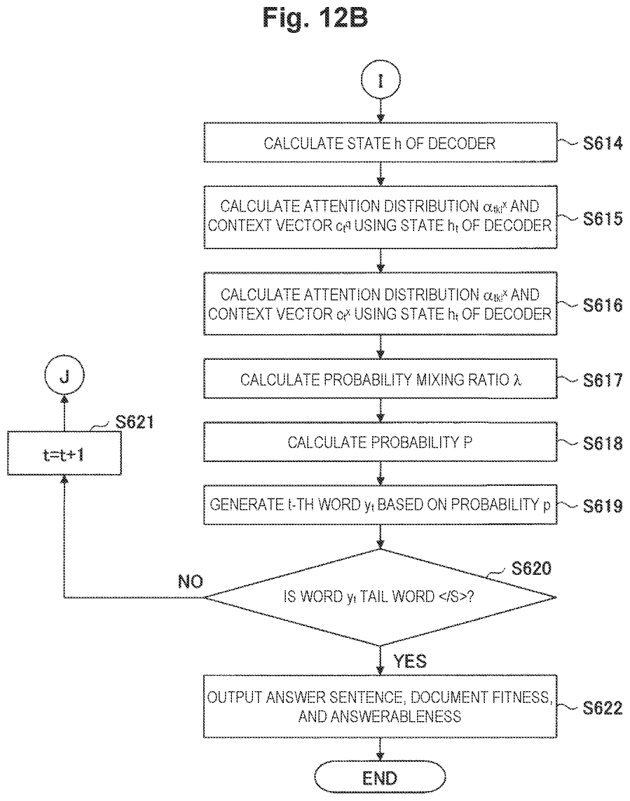

The process of question-answering performed by the question-answering apparatus 10 according the second embodiment of the present invention (question-answering process) will be described below with reference to FIGS. 12A and 12B. FIGS. 12A and 12B are a flowchart showing an example of the question-answering process according to the second embodiment of the present invention. Note that as described above, during question-answering, the question-answering apparatus 10 includes the functional components and storage unit shown in FIG. 2.

Step S601: The input unit 102 acquires test data. Note that it is assumed below that a document set contained in the test data is made up of K documents.

The processes of steps S602 to S612, S614 to S619, and S621 are similar to those of steps S502 to S512, S514 to S519, and S521 above, respectively, and thus description thereof will be omitted. However, in the processes of steps S602 to S3612, S614 to S619, and S621, the question, document set, and answer style contained in the test data inputted in step S601 above are used. Also, as the parameter of the answer sentence generating model (neural network), the parameter learned in the learning process is used.

Step S613: The word sequence vectorization unit 103 searches the word vector storage unit 101 for each word contained in the word sequence (y₁, . . . , yₜ₋₁) of the output word generated in step S619, converts each word into a word vector, and thereby converts the word sequence into a vector sequence Y=[Y₁, Y₂, . . . , Y_{T}]∈R^{v×T}.

In so doing, before converting the word sequence (y₁, y₂, . . . , yₜ₋₁) into a vector sequence Y, the word sequence vectorization unit 103 inserts a special character at the head of the word sequence according to a specified answer style (i.e., the answer style contained in the test data) and inserts a special character </S> at the tail. Also, if the length of the word sequence is less than T after the special character according to the answer style and the special character </S> are inserted, the word sequence vectorization unit 103 pads the word sequence with a special character <PAD> such that the length of the word sequence will become equal to T. Furthermore, when converting a word not stored in the word vector storage unit 101 into a word vector, the word sequence vectorization unit 103 does so by treating the word as a special character <UNK>. Note that according to the second embodiment, the word vector storage unit 101 stores data associating special characters according to answer styles with the word vectors of the special characters.

Step S620: The style-dependent answer sentence generation unit 105 determines whether the output word yₜ generated in step S619 is a special word </S> (i.e., a special word that indicates the tail). If it is determined that the output word yₜ is not a special word </S>, the question-answering apparatus 10 runs the process of step S621. On the other hand, if it is determined that the output word yₜ is a special word </S>, the question-answering apparatus 10 runs the process of step S622.

Step S622: The output unit 107 outputs an answer sentence made up of the output words yₜ generated in step S619, the document fitness βₖ calculated in step S610, and the answerableness a calculated in step S611. This provides the document fitness βₖ of each document contained in the document set and answerableness a of the document set as well as the answer sentence according to the answer style.

The present invention is not limited to the embodiments concretely disclosed above, and various modifications and changes can be made without departing from the appended claims.

### REFERENCE SIGNS LIST

10 Question-answering apparatus
101 Word vector storage unit
102 Input unit
103 Word sequence vectorization unit
104 Word sequence matching unit
105 Style-dependent answer sentence generation unit
106 Parameter learning unit
107 Output unit
108 Document fitness calculation unit
109 Answerableness calculation unit

1. A question-answering apparatus comprising:
an answer generator configured to accept as input a document set made up of one or more documents, a question sentence, and a style of an answer sentence for the question sentence and to generate the answer sentence for the question sentence using a learned model based on the document set, wherein
the learned model determines probability of generation of words contained in the answer sentence, according to the style, when generating the answer sentence.

2. The question-answering apparatus according to claim 1, wherein:
the answer generator generates the answer sentence using words contained in the document set, words contained in the question sentence, and words contained in a preset vocabulary set; and
in the generating the words contained in the answer sentence, the learned model determines a ratio that indicates which of the words contained in the vocabulary set, the words contained in the question sentence, or the words contained in the vocabulary set, importance is to be attached to, the ratio being determined according to the style.

3. The question-answering apparatus according to claim 2, wherein, in the generating the words contained in the answer sentence, the learned model determines the probability of generation by combining an attention distribution on the words contained in the document set, an attention distribution on the words contained in the question sentence, and a probability distribution on the words contained in the vocabulary set by using the ratio.

4. The question-answering apparatus according to claim 1, wherein the answer generator determines fitness of the document in generating the answer sentence and answerableness of the document set to the question sentence by using the learned model.

5. A learning apparatus comprising:
an answer generator configured to accept as input a document set made up of one or more documents, a question sentence, a style of an answer sentence for the question sentence, and a right answer for the answer sentence according to the answer style and to determine probability of generation of words contained in an answer sentence for the question sentence based on the document set by using a learned model; and
an updater configured to update a parameter of the learned model based on a loss determined using the right answer and the probability of generation.

6. The learning apparatus according to claim 5, wherein the style includes at least “word” indicating that the answer sentence is expressed by a word or “phrase” indicating that the answer sentence is expressed by a phrase, and “natural sentence” indicating that the answer sentence is expressed by a natural sentence.

7. A method, the method comprising:
accepting, by an answer generator, as input a document set made up of one or more documents, a question sentence, and a style of an answer sentence for the question sentence and generating the answer sentence for the question sentence using a learned model based on the document set, wherein
the learned model determines probability of generation of words contained in the answer sentence, according to the style, when generating the answer sentence.

8. (canceled)

9. The question-answering apparatus according to claim 2, wherein the answer generator determines fitness of the document in generating the answer sentence and answerableness of the document set to the question sentence by using the learned model.

10. The question-answering apparatus according to claim 3, wherein the answer generator determines fitness of the document in generating the answer sentence and answerableness of the document set to the question sentence by using the learned model.

11. The method according to claim 7, wherein the answer generator determines fitness of the document in generating the answer sentence and answerableness of the document set to the question sentence by using the learned model.

12. The method according to claim 7, the method further comprising:
updating, by an updater, a parameter of the learned model based on a loss determined using the right answer and the probability of generation.

13. The method according to claim 7, wherein
the answer generator generates the answer sentence using words contained in the document set, words contained in the question sentence, and words contained in a preset vocabulary set; and
in the generating the words contained in the answer sentence, the learned model determines a ratio that indicates which of the words contained in the vocabulary set, the words contained in the question sentence, or the words contained in the vocabulary set, importance is to be attached to, the ratio being determined according to the style.

14. The method according to claim 12, wherein the style includes at least “word” indicating that the answer sentence is expressed by a word or “phrase” indicating that the answer sentence is expressed by a phrase, and “natural sentence” indicating that the answer sentence is expressed by a natural sentence.

15. The method according to claim 13, wherein the answer generator determines fitness of the document in generating the answer sentence and answerableness of the document set to the question sentence by using the learned model.

16. The method according to claim 13, wherein, in the generating the words contained in the answer sentence, the learned model determines the probability of generation by combining an attention distribution on the words contained in the document set, an attention distribution on the words contained in the question sentence, and a probability distribution on the words contained in the vocabulary set by using the ratio.

17. The method according to claim 14, wherein:
the answer generator generates the answer sentence using words contained in the document set, words contained in the question sentence, and words contained in a preset vocabulary set; and
in the generating the words contained in the answer sentence, the learned model determines a ratio that indicates which of the words contained in the vocabulary set, the words contained in the question sentence, or the words contained in the vocabulary set, importance is to be attached to, the ratio being determined according to the style.

18. The method according to claim 14, wherein the answer generator determines fitness of the document in generating the answer sentence and answerableness of the document set to the question sentence by using the learned model.

19. The method according to claim 16, wherein the answer generator determines fitness of the document in generating the answer sentence and answerableness of the document set to the question sentence by using the learned model.

20. The method according to claim 17, wherein, in the generating the words contained in the answer sentence, the learned model determines the probability of generation by combining an attention distribution on the words contained in the document set, an attention distribution on the words contained in the question sentence, and a probability distribution on the words contained in the vocabulary set by using the ratio.

21. The method according to claim 20, wherein the answer generator determines fitness of the document in generating the answer sentence and answerableness of the document set to the question sentence by using the learned model.
